(19) United States
(12) Patent Application Publication
(10) Pub. No.: US 2014/0157512 A1
(43) Pub. Date: Jun. 12, 2014

(54) Hydro-Therapeutic Jet Massage Device

(71) Applicant: Brian Yanity, Fullerton, CA (US)

(72) Inventor: Brian Yanity, Fullerton, CA (US)

(21) Appl. No.: 13/893,095

(22) Filed: May 13, 2013

Related U.S. Application Data
(60) Provisional application No. 61/647,499, filed on May 15, 2012.

(51) Int. Cl. A61H 33/00

(52) U.S. Cl. CPC A61H 33/6047
USPC 4/541.4; 4/541.3

(57) ABSTRACT

A jet massage device including a pump unit submersible in liquid; an electronic unit electrically coupled to the pump unit, wherein the electronic unit includes a programmable component for determining one or more of the following of the pump unit: power ramp, voltage level, current level, water flow volume, water flow rate or frequency pulsing of a water stream; and a spa jet assembly, coupled to the pump unit and the electronic unit for delivering the water stream.

### CLAIM OF PRIORITY UNDER 35 U.S.C. §119

The present application for patent claims priority to Provisional Application No. 61/647,499 entitled “Hydro-Therapeutic Jet Massage Device” filed May 15, 2012, and assigned to the assignee hereof and hereby expressly incorporated by reference herein.

### FIELD

This disclosure relates generally to apparatus for a jet massage. More particularly, the disclosure relates to a hydro-therapeutic bathtub jet massage device.

### BACKGROUND

Jet massage devices are often used in a bathtub, hot tub (e.g., spa hot tub) or a whirlpool. Many conventional jet massage devices are built-in to the bathtub or the hot tub or a whirlpool. Other jet massage devices are heavy add-ons to a bathtub, a hot tub or a whirlpool, that when added to an already built bathtub, hot tub or whirlpool, becomes part of its permanent fixture. There is a desire to have overall portability and lightweight features of the jet massage device with no permanent attachment to the bathtub, bathroom floor or walls. Also, it would be desirable for a jet massage device which can be moved or stored away easily when not in use. It would be desirable for a jet massage device to be used with one bathtub and then moved to a different bathtub conveniently. In some conventional jet massage devices, when a jet massage device is used for an extended period of time, the motor may overheat. Thus, it would be desirable to have a jet massage device include an efficient form of heat dissipation.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Disclosed is jet massage device. According to one aspect, a jet massage device including a pump unit submersible in liquid; an electronic unit electrically coupled to the pump unit, wherein the electronic unit includes a programmable component for determining one or more of the following of the pump unit: power ramp, voltage level, current level, water flow volume, water flow rate or frequency pulsing of a water stream; and a spa jet assembly, coupled to the pump unit and the electronic unit for delivering the water stream.

Advantages of the present disclosure may include overall portability and light weight of the jet massage device, ability to be moved or stored easily, and using the tube or pool water to cool the pump motor by aiding in heat dissipation since the pump unit may be entirely or partially submerged in water.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of a jet massage device.

FIG. 2 illustrates an example of the electronic unit and the pump unit.

FIG. 3 illustrates an example of an assembled jet massage device.

FIG. 4 illustrates an example of the jet massage device in operation with the pump unit in a bathtub with water and the electronic unit outside of the bathtub, wherein control of the jet massage device is via the remote control.

FIG. 5 illustrates an example of a directional spa jet assembly coupled to a water supply tube and an air supply tube.

FIG. 6 illustrates a side view example of the directional spa jet assembly of FIG. 5.

FIG. 7 illustrates an example of a whirly rotating spa jet assembly 770 coupled to a water supply tube 160 and an air supply tub 150.

FIG. 8 illustrates a side view example of the whirly rotating spa jet assembly of FIG. 7.

FIG. 9 illustrates an example of a spa jet assembly coupled to a clip-type holder on the pump housing.

FIG. 10 illustrates an example of a spa jet assembly in the bathtub free from a clip-type holder.

FIG. 11 illustrates a first view of an example of the jet massage device with a jet stand.

FIG. 12 illustrates a second view of the example of the jet massage device with the jet stand of FIG. 11.

FIG. 13 illustrates a third view of the example of the jet massage device with the jet stand of FIG. 11.

FIG. 14 illustrates a fourth view of the example of the jet massage device with the jet stand of FIG. 11.

FIG. 15 illustrates another example of a jet massage device.

FIG. 16 illustrates an example of a pump unit with a reservoir.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

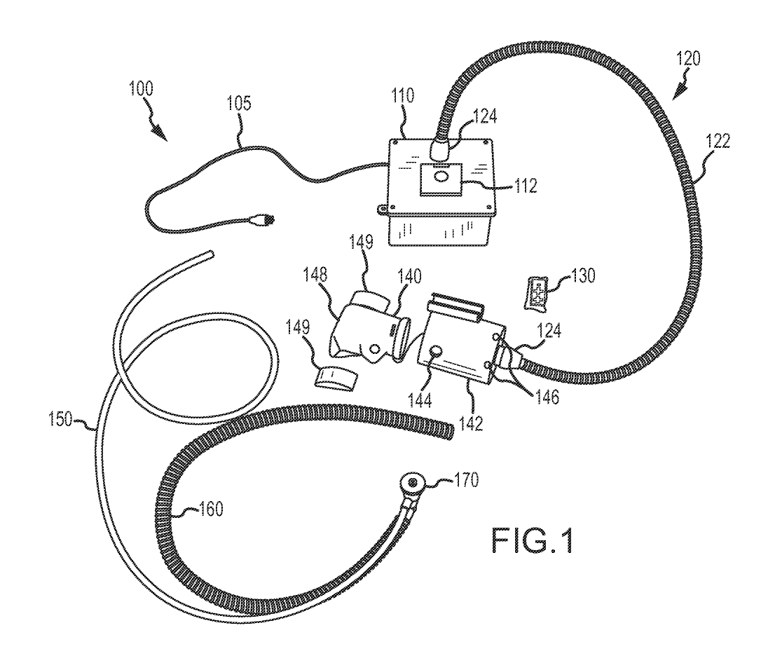

FIG. 1 illustrates an example of a jet massage device 100. The jet massage device 100 includes a power cord 105, an electronic unit 110, one or more electrical cables 120, a remote control 130, a pump unit 140, an air supply tube 150, a water supply tube 160, and a spa jet assembly 170. In one example, the water supply tube 160 is made of flexible material to allow bending and curving. In one example, more than one spa jet assemblies are attached to a single pump unit 140 through the use of tube fittings, or multiple water tube outlets on the pump unit 140. In one example, more than one water supply tubes are attached to a single pump unit 140 through the use of tube fittings, or multiple water tube outlets on the pump unit 140. In one example, more than one air supply tubes are attached to a single pump unit 140 through the use of tube fittings, or multiple water tube outlets on the pump unit 140.

In one example, the electronic unit 110 includes a manual control 112, for example, to turn it ON and OFF. In one example, the one or more electrical cables 120 connect the electronic unit 110 with the pump 140. The one or more electrical cables 120 may be housed in a flexible housing tube 122. The ends of the flexible housing tube 122 may include one or more fittings 124 (e.g., adapter or conduit fittings). The pump unit 140 is located inside a pump housing 142. In one example, the flexible housing tube 122 is connected through the pump housing 142 via a fitting 124. In one example, the pump housing 142 includes an output hole 144 and/or one or more small holes 146. The quantity of the output hole 144 and/or small holes 146 are design choices which may vary according to many factors, including but not limited to, the type of pump unit being used. In one example, the pump unit 140 includes a strainer 148 and one or more foam paddings 149. In one example, the strainer 148 is a mesh sponge or a filter foam. In one example, the pump unit 140 is entirely or partially submerged in water, and the water can cool the pump motor 147 by aiding in heat dissipation.

In one example, the jet massage device 100 of the present disclosure is a portable, hand-held hydro-therapeutic bath tub jet massage device. In one example, it can be controlled with the use of a remote control 130. The jet massage device 100 may be portable and lightweight and may allow a user to safely massage any part of the user's body while in any bathtub. An additional feature is an adjustable spa jet air-water stream, with freedom of motion. Although the jet massage device 100 is described herein as being used in a bathtub, one skilled in the art would understand that the jet massage device may be used in any pool of water or liquid and be within the scope and spirit of the present disclosure.

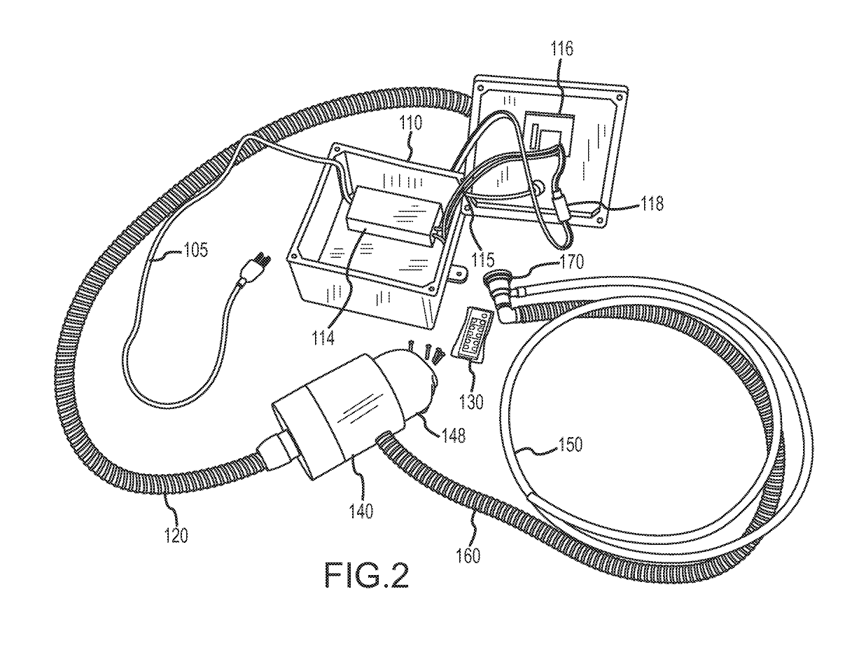

FIG. 2 illustrates an example of the electronic unit 110 and the pump unit 140. In one example, the electronic unit 110 includes an AC/DC transformer-power supply 114 (e.g., waterproof 120 VAC/12 VDC transformer-power supply), a DC power control circuit 116, electrical wires 115 connecting the AC/DC transformer-power supply 114 and the DC power control circuit 116, and a fuse 118. In another example, the electronic unit 110 further includes a programmable circuit (not shown). And, in one example, the programmable circuit includes a processor (not shown) coupled to a memory unit (not shown) for storing and executing software and/or firmware programs.

In one example, a programmable power supply (e.g., programmable DC power control circuit) is used. For example, the programmable power supply may pulse at different frequencies, “ramps of power”, or provide any variation in voltage level, and therefore water flow volume or rate, provided by a solid-state, programmable IC, as long as the “ramps” or pulses of power do not generate excessive transient currents in the pump motor 147 or control circuit. In one example, electronic circuit elements, familiar to those skilled in the art, for controlling and regulating excess voltage and current transients or surges may be integrated into a control circuit of the jet massage device.

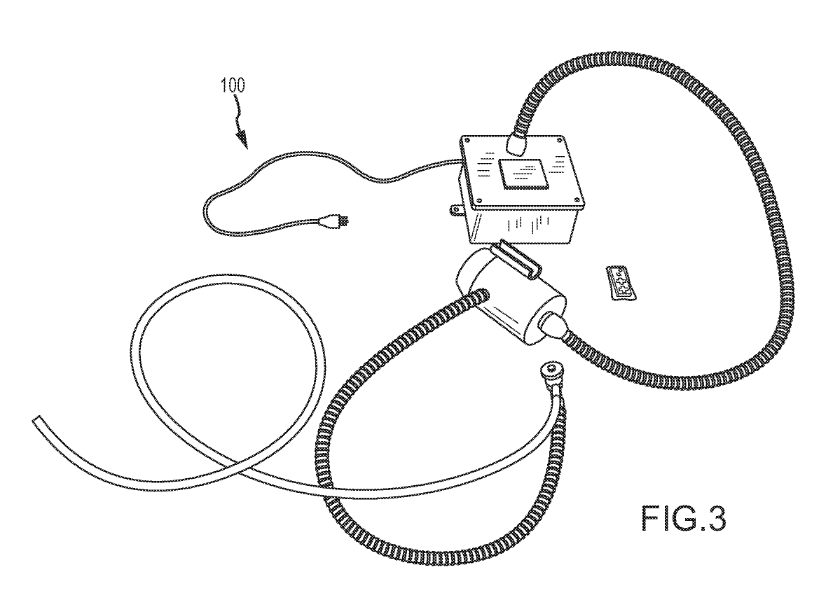

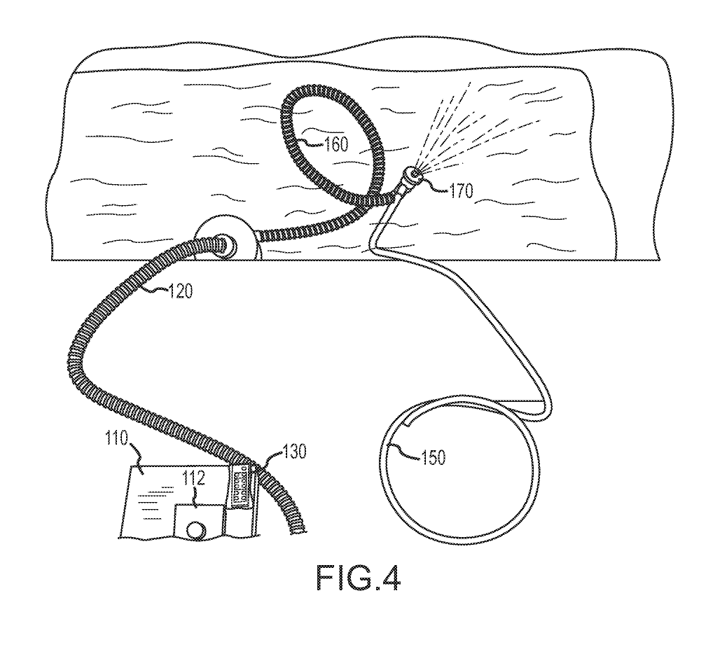

FIG. 3 illustrates an example of an assembled jet massage device 100. FIG. 4 illustrates an example of the jet massage device 100 in operation with the pump unit 140 in a bathtub with water and the electronic unit 110 outside of the bathtub, wherein control of the jet massage device is via the remote control 130. For example, the electronic unit 110 (or portions thereof) may be controlled by the remote control 130. The remote control 130 may use one or more of the following wireless technologies: infrared (IR), radio frequency (RF), sonar, optical, etc. The remote control 130 may be used to adjust the power of the pump unit 140, and consequently the flow volume of the water jet, without having the user touch the power supply and/or the electronic unit 110 directly. The remote control 130 may be used to control (e.g., turn on or off) any program applications stored in the programmable circuit of the electronic unit 110. Additionally, the remote control 130 may be used to select and/or operate programmable software or firmware within the programmable unit. The remote control 130 may include sealants or a transparent cover or case to make it waterproof.

In one aspect, the pump unit 140 is a 12 V submersible bilge pump unit which may be resting or floating in a water-filled bathtub. The pump unit 140 may not need to be anchored to the bathtub. It submerges and floats on its weight. In another example, the pump unit 140 may be anchored to the bathtub, for example, through the use of suction cups, hooks, screw, etc. One skilled in the art would understand that there are many types of fasteners that may be used to anchor the pump unit 140 to the bathtub without affecting the scope and spirit of the present disclosure. Thus, other types of fasteners (though not specifically mentioned herein) may be used without affecting the scope and spirit of the present disclosure.

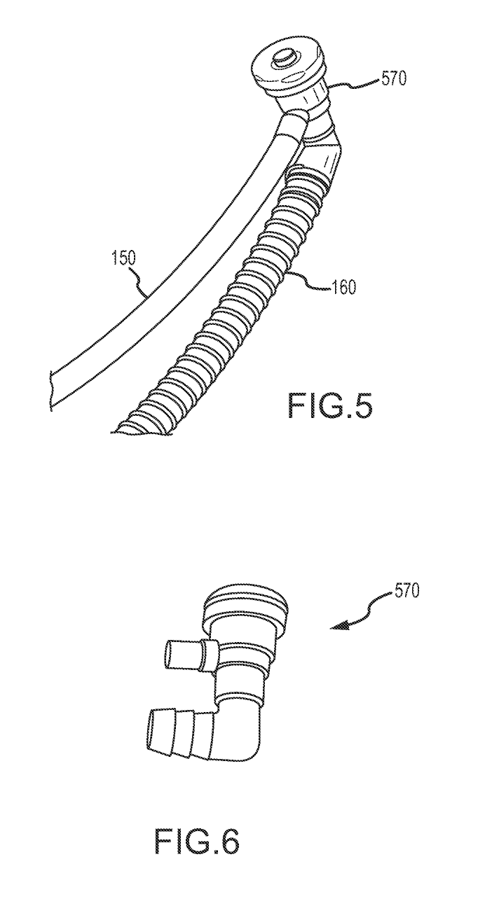

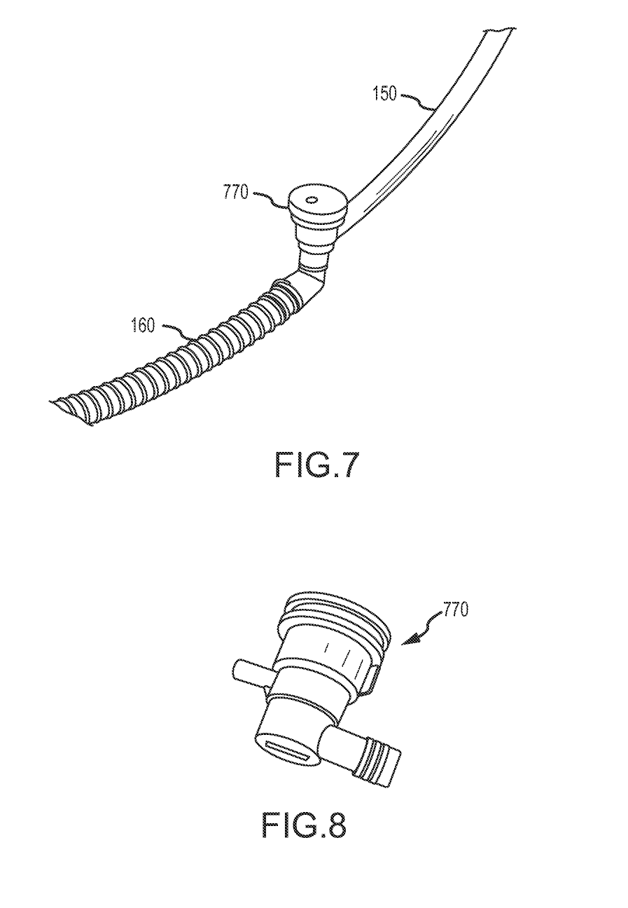

FIG. 5 illustrates an example of a directional spa jet assembly 570 coupled to a water supply tube 160 and an air supply tube 150. FIG. 6 illustrates a side view example of the directional spa jet assembly 570 of FIG. 5. FIG. 7 illustrates an example of a whirly rotating spa jet assembly 770 coupled to a water supply tube 160 and an air supply tube 150. FIG. 8 illustrates a side view example of the whirly rotating spa jet assembly 770 of FIG. 7. FIGS. 5, 6, 7 and 8 illustrate two examples of the spa jet assembly 170 shown in FIG. 1.

In one aspect, the jet message device 110 includes a spa jet assembly 170. The spa jet assembly 170 may include two input holes: a first input hole is connected to an air supply tube 150 and a second input hole is connected to a water supply tube 160. The water supply tube 160 is also connected to the pump unit 140 where water flow is fed from the pump unit 140 to the second input hole of the spa jet assembly 170. In one example, the water supply tube 160 is made of material that allows it to have a flexible quality for bending. The spa jet assembly 110 may also include an output hole 144 where a mixture of water and air exits the spa jet assembly to create a massage sensation on the user's body.

In one example, the amount of air in the mixture of air and water is adjustable to provide a desired proportion of air in the air-water stream exiting out of the spa jet assembly 170. By adjusting the amount of air inputted into the spa jet assembly 170, a user can achieve different massage sensations. This adjustment may be achieved manually by placing a finger over the air supply tube 150 connected as an input to the spa jet assembly 170. In one example, the different massage sensations may be achieved by manually covering portions of an opening of the air supply tube 150. In one example, the water stream is aerated.

Alternatively, the amount of air inputted into the spa jet assembly 170 may be controlled by a mechanical valve that can be manually adjusted by the user, or electro-mechanically by the electronic unit 110, for example, through its programmable circuit. In one example, the mechanical valve is associated with the air supply tube 150.

In one example, the water supply tube 160 connects from the pump unit 140 (which may be resting on the floor of the bathtub or floating in the bathtub) to the second input hole which may be located on the top side of the spa jet assembly 110. The pump unit 140 may be placed in the bathtub with two waterproof electric cables (e.g., a positive lead and a negative lead) connecting it to the power supply, which rests on the bathroom floor outside of the bathtub. In one example, the power supply voltage is 0 to 12 Volts and its voltage output is adjustable. In one example, the AC/DC transformer-power supply 114 comprises of two discrete components: an AC/DC transformer component and a power supply component. It is not necessary for the two discrete components (the AC/DC transformer component and the power supply component) to be housed together. In one example, they are separately housed.

The electronic unit 110 is typically not intended to be submerged in water. However, certain precautions may be added to make the electronic unit 110 waterproof so that in the event of an accident where the electronic unit 110 is submerged into the bathtub filled with water, the user will still be protected from an electrical short circuit. In one example, sealant is used around the exterior boundary of the electronic unit 110 to ensure that it is waterproof. In another example, sealant is also applied to the boundaries of each of the subunits or components within the electronic unit 110. For example, the AC/DC transformer-power supply is waterproofed with a coating of sealant. For example, the power supply is waterproofed with a coating of sealant. For example, the control circuit is a waterproofed with a coating of sealant. For example, the programmable unit is a waterproofed with a coating of sealant. Additionally, waterproofing is applied to the electrical cables and wires that connect the various subunits within the electronic unit 110.

In one example, the two waterproof electric cables may be housed within a protective flexible tube connected between the power supply and the pump unit 140. In one example, the power supply includes a fuse, for example, to protect against an over-current supply (or short) to the pump motor 147 (not shown). The fuse may be housed within a waterproof housing. In one example, the fuse has an automotive-type overcurrent fuse rating based on recommended rating provided by the submersible pump manufacturer. In one example, the power supply is a direct current (DC) power supply with overcurrent and/or over-voltage protection. For example, the DC power supply may be rated for an operating range of approximately between 0V to 19V. In another example, the power supply is an alternating current (AC) power supply with overcurrent and/or over-voltage protection.

In one aspect, isolated electrical grounds of respective alternating current (AC) and direct current (DC) circuits in the power supply provide additional safety protection, following the National Electric Code guidelines for safely powering low-voltage electrical devices in occupied pools, baths and spas.

In one aspect, all the tubes for housing the electrical cables and wires (i.e., flexible electrical conduits) are sealed at all ends with waterproof sealant, such as silicone adhesive or equivalent. In addition, at the end of the flexible electrical conduit, a fitting is installed for coupling the flexible electrical conduits to the pump unit 140. And, at the other end of the flexible electrical conduit, another fitting is installed for coupling the flexible electrical conduit to the electronic unit, for example, to the power supply. One skilled in the art would understand that although in one aspect, the electronic unit 110 includes one or more of the following: power supply, control circuit and/or programmable unit, in another aspect, the power supply, control circuit and/or programmable unit are separately housed and are separate individual units. In one example, the fittings (e.g., adapter fittings, conduit fittings, etc.) are strong enough to allow either the pump unit 140 and/or power supply to be safely lifted by the flexible electrical conduit or tubing without the risk of damaging the electrical connections, cables and wires.

In one example, the pump unit 140 includes a pump motor 147 housed in a pump housing 142. The pump housing 142 may be made of plastic, fiber glass, or an equivalent durable material. The pump housing 142 provides protection for the pump motor 147, such as protection against having the pump motor 147 scrape or bump against the sides of the bathtub as it submerges and floats in the bathtub. In one example, the pump housing 142 is cylindrical in shape and includes a top side and a bottom side. In one example, the bottom side includes an opening for water to enter into the pump motor 147.

In one example, the pump housing 142 includes one or more holes on the top side of the pump housing 142 for pressure equalization, that is, by allowing air bubbles trapped in the pump housing 142 to flow out of the one or more holes. Inside the pump housing 142, foam padding 149 may be placed between the pump motor 147 and the inner wall of the pump housing 149 to provide additional protection for the pump motor 147. The foam padding 149 adds buoyancy. And, the foam padding 149 may reduce audible noise from the pump motor 147. In one example, the foam padding 149 is placed on the top portion of the pump unit 140. The foam padding 149 allows the top portion of the pump unit 140 to float if there is water in the bathtub, and the bottom portion of the pump unit 140 (i.e., the location of the pump motor 147) to be submerged in water for heat dissipation. This is unlike a pump unit that is hooked or attached to the side of the bathtub at a fixed height where the pump unit will only touch the water if the water level in the bathtub is high enough to reach the pump unit.

In one example, the bottom side of the pump housing 142 includes a strainer 148 (e.g., a mesh sponge) to filter the water (e.g., coarse filtration) before the water enters the pump motor 147. In one example, the strainer 148 is held in place under the pump motor 147 at the point where the water enters the pump motor 147. One skilled in the art would understand that there are many ways to hold or secure the strainer in place relative to the pump motor (i.e., within the pump housing) and that any of the ways employed is within the scope and spirit of the present application. For example, clips, other fasteners or Velcro type tapes may be used. Or, in one alternative, the strainer 148 is wrapped around the bottom end of the pump motor 147 where the water enters the pump motor 147. In addition to serving as a filtration of the water before the water enters the pump motor 147 and eventually exits through the spa jet assembly 170, the strainer 148 may also serve to cushion the pump motor 147 if it rests on the floor of the bathtub. The strainer 148 is removable (for example, for cleaning or for replacing).

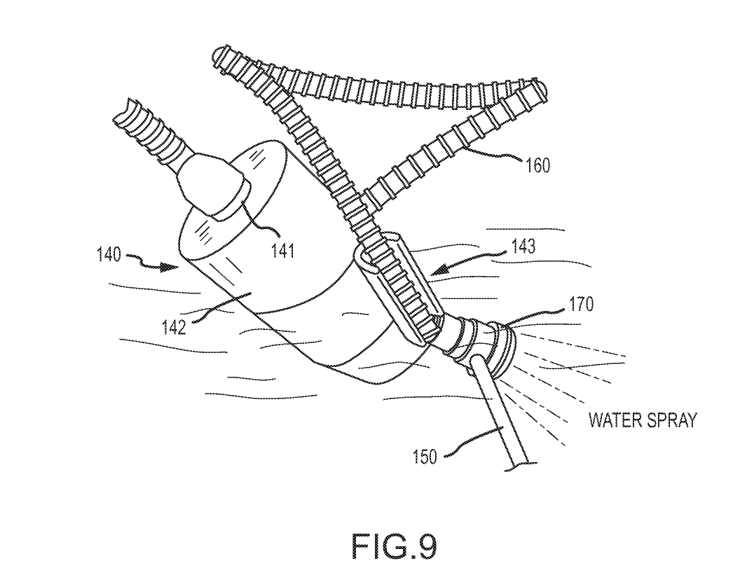

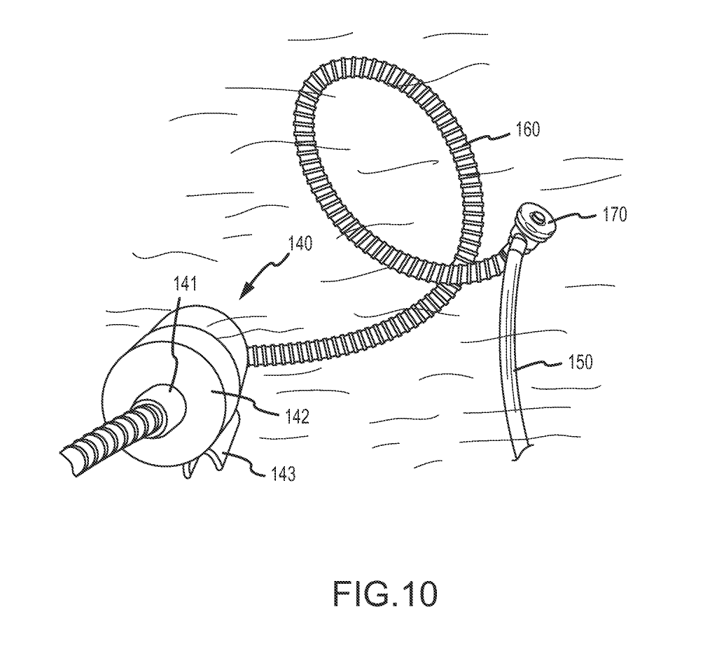

FIG. 9 illustrates an example of a spa jet assembly 170 coupled to a clip-type holder 143 on the pump housing 142. In the example of FIG. 9, the pump housing 142 includes a clip-type holder 143 mounted on one side, to allow the user to attach the water supply tube 160 and/or spa jet assembly 170 to the pump housing 142 (for example, while it is floating in the bathtub). FIG. 10 illustrates an example of a spa jet assembly 170 in the bathtub free from a clip-type holder 143. In one example, the pump housing 142 includes one or more of the following: a suction cup, a hook, a non-permanent fastener (e.g., Velcro and removable tape), or a permanent fastener (e.g., screw).

In one example, an outlet opening 141 (e.g., outlet barb) of the pump unit 140 is connected by the water supply tube 160 (e.g., via a barb connector of standard size) to the spa jet assembly 170 held in the user's hand, which is also connected (e.g., via a smaller connector of standard size) to an air supply tube 150 for air supply. In one example, the diameter of the water supply tube 160 is greater than the diameter of the air supply tube 150. Any combination of standard sized air supply tube and/or water supply tube may be used. And fittings (e.g., adapter fittings, conduit fittings, etc.) may also be used (as needed) with either or both of the air supply tube and/or water supply tube. In one example, the water supply tube 160 and air supply tube 150 are both of a standard size, allowing different models/manufacturers of spa jet assemblies 170 with matching barb-style connectors to be changed out on the jet massage device 100 of the present disclosure.

In one example, a “muffler” may be added on the air supply tube 150 to reduce noise during operation of the jet massage device 100. In one example, an air control valve mounted above the spa jet assembly 170 may be included and is operated by the user to control the amount of air bubbles in the air-water stream exiting from the spa jet assembly 170.

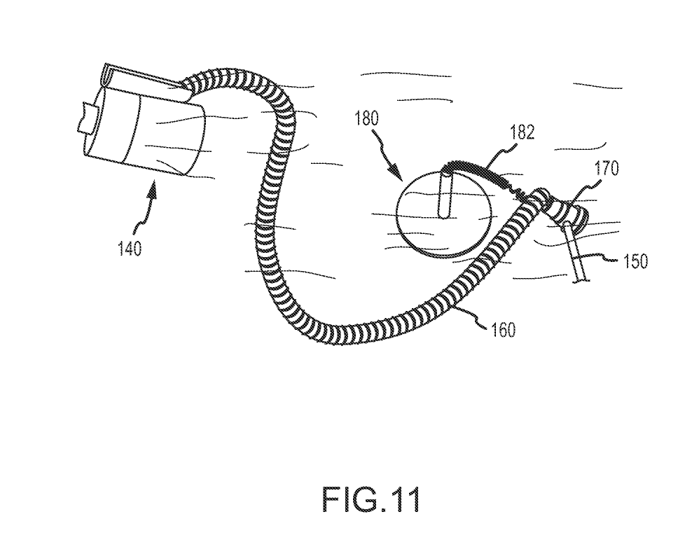

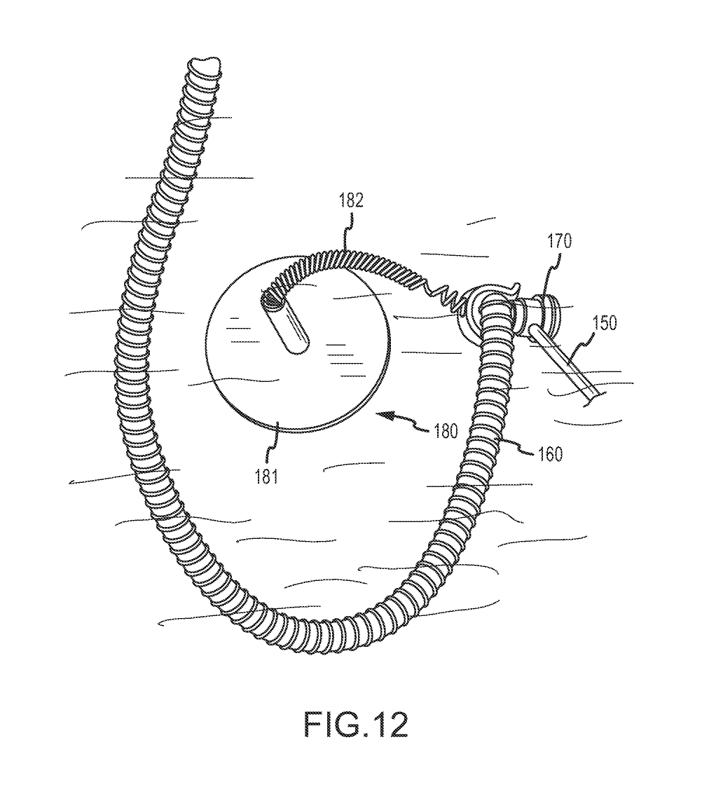

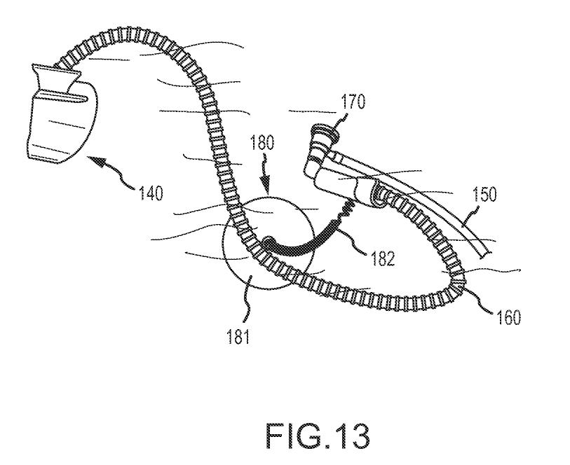

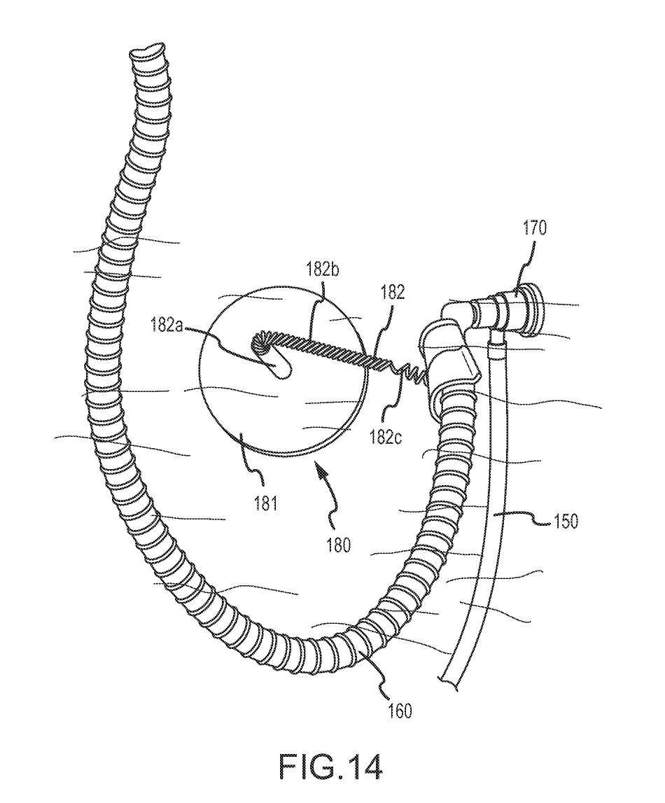

FIGS. 11, 12, 13 and 14 illustrate various views of an example of the jet massage device 100 with a jet stand 180. Shown in FIGS. 11, 12, 13 and 14 is the spa jet assembly 170 coupled to the jet stand 180. In one example, the jet stand 180 is flexible and bends with jet massage device 100 in operation. In one example, the flexibility of the jet stand 180 is accomplished by a coil 182 as shown in FIGS. 11-14. In one example, the coil 182 may include multiple sections of coil, each section with a varying coil windings (i.e., coil tightness) from the coil sections. For example, as illustrated in FIG. 14, the coil 182 includes 3 sections: a first section 182a extending substantially perpendicular to the jet stand plate 181, a second section 182b with a tighter coil winding than a third section 182c.

In one aspect, the jet massage device 100 allows the user to hold the small spa jet assembly 170, allowing freedom of movement and positioning of the air-water jet stream. Being capable of being hand-held, the jet massage device 100 may be used for focused massage of any part of the user's body as the user chooses. For example, the user can control the air-water stream by the following:
Adjusting the pump motor speed and water flow volume, for example, by using a remote control or a manual control (e.g., a dial) on the power supply. In one example, the pump motor speed and/or water flow volume may be programmable through the use of the programmable circuit in the electronic unit 110.
Adjusting the 3-dimensional position, angle, and distance from the user's targeted massage area, by holding the spa jet assembly 170 in the bathtub in the user's hand, or attaching it the clip-type holder 143 on the pump housing 142 and adjusting the position of the floating pump unit 140, attaching it to the side of the bathtub by suction cups or other attachments, or attaching it to a clip-type holder 143 on an adjustable jet stand 180 that rests on the bottom of the bathtub, allowing “hands-free” operation at any angle the user chooses. The jet stand 143 may also be attached to the bottom or side of the bathtub by suction cups or other attachments. The spa jet assembly 170 may also be lifted out of the water for a direct water jet massage while the pump unit 140 stays in the water.
Adjusting the volume of air flow or air bubbles entering the air-water stream by placing a user's finger (e.g., thumb) on the intake of the air supply tube, or controlling the air intake by a mechanical valve or other manner.
Changing out different spa jet assemblies on the same air and water tubes, for different massage effects particular to different spa jet assembly designs.

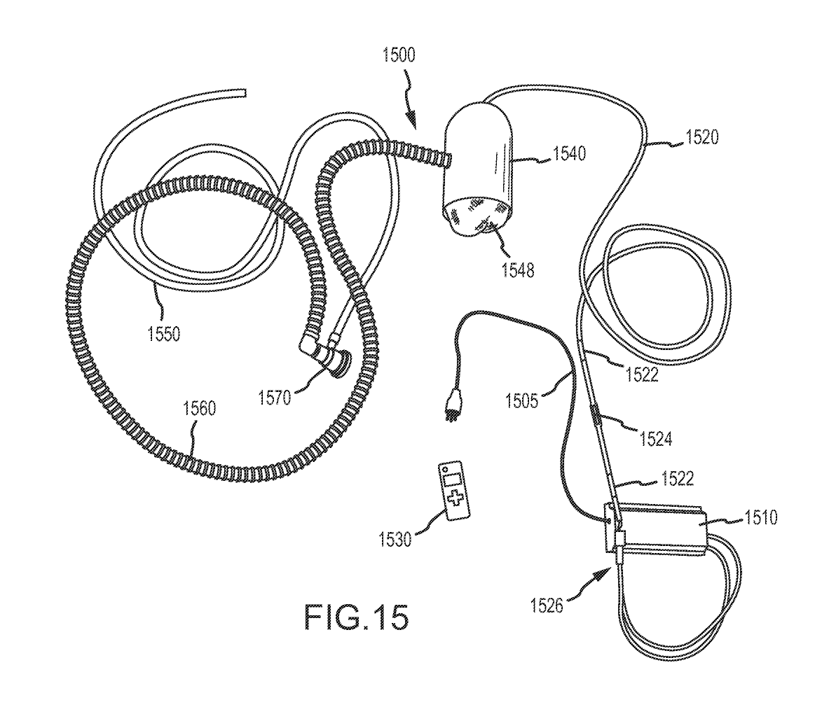

FIG. 15 illustrates another example of a jet massage device 1500. The jet massage device 1500 includes a power cord 1505, a power supply 1510, an electrical cable 1520, a remote control 1530, a pump unit 1540, an air supply tube 1550, a water supply tube 1560, and a spa jet assembly 1570. In one example, the power supply 1510 is a 12V DC power supply.

In one example, the electrical cable 1520 includes a fuse 1526. In one example, the fuse 1526 is housed in a waterproof, automotive type fuse holder that is in-line with the electrical cable 1520. In one example, the electrical cable 1520 includes two conductors 1522 and a control circuit 1524. In one example, the control circuit 1524 is sequentially placed between the two conductors 1522 as shown in FIG. 15. In one example, the control circuit 1524 is a DC control circuit. The conductors 1522 are submersible in water (e.g., submarine conductors). In one example, one of the conductors 1522 is associated with a positive lead and the other of the conductors 1522 is associated with a negative lead. In one example, waterproof splices are used to implement one or more of the conductors 1522, the control circuit 1524 and/or the fuse 1526. In one example, the electronic unit 110 is electrically spliced on the electrical cable 1520, wherein the electronic unit 110 may include the control circuit 1524.

In one example, the water supply tube 1560 is made of flexible material to allow bending and curving. Unless disclosed here, other features of the jet massage device 1500 may be the same or similar as those of the jet massage device 100 illustrated herein and in the previous figures.

In one example, the jet massage device (100 or 1500) includes waterproof light emitting diodes (LEDs), or other type of low-voltage lighting device(s), for example on pump unit or other part of the jet massage device. In one example, the LEDs or low-voltage lighting devices are connected to the same electrical circuits as the pump unit. In one example, the LEDs or low-voltage lighting devices change light intensity representative of the intensity of the water flow output from the pump unit 140. In another example, the power supply and control circuit of the lights are separate from that of the pump unit 140. In one example, LEDs or low-voltage lighting devices are also included one or more of the spa jet assembly and water supply tube.

In one example, the jet massage device (100, 1500) includes one or more DC control circuits units, for example, coupled between a DC power supply and pump cables. In one example, the DC control circuit unit includes different control features, including programmable circuits. The DC control circuit may use standardized electrical connections that are readily found in a consumer supply store. The DC control circuit may offer different control features (pump power pulsing, ramping, etc.) and/or massage effects. In one example, the power supply may be directly connected to the pump cable, thus enabling the pump unit to be powered with no form of control whatsoever.

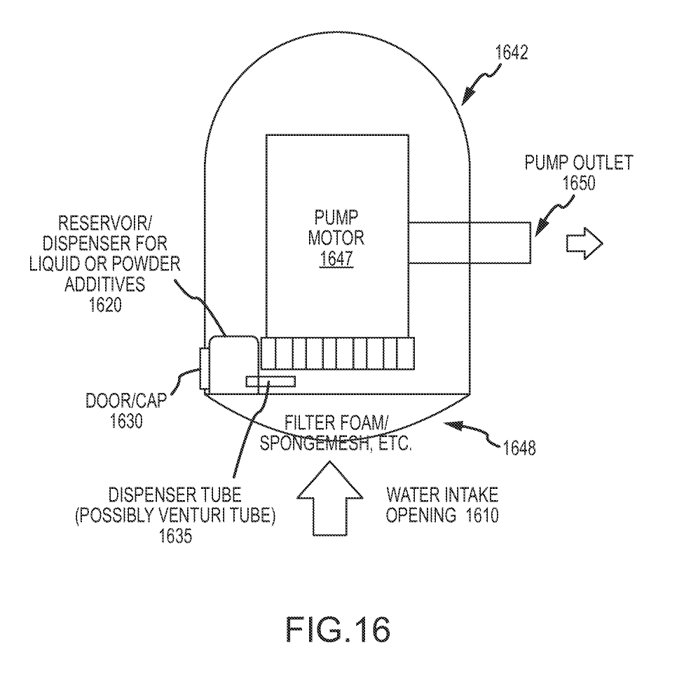

FIG. 16 illustrates an example of a pump unit 1600 with a reservoir 1620. In one example, the pump unit 1600 includes a pump motor 1647, a pump housing 1642, and a pump strainer 1648. In one example, the pump strainer is a filter foam or a sponge mesh. The pump unit 1600 also includes a water intake opening 1610 and a pump outlet 1650. In one aspect, the water intake opening 1610 is part of the strainer or is the strainer's pore openings that allow water to flow into the pump unit 1600. In one example, the pump unit 1600 includes a reservoir 1620 (a.k.a., a dispenser) for dispensing liquid or powder additives. A door 1630 (e.g., a cap) is associated with the reservoir 1620 for inputting the dispensing liquid or powder additives. And, a dispenser tube 1635 (which may be a dispenser outlet) is associated with the reservoir 1620 for dispensing the liquid or powder additives into, for example, a bathtub or pool of water. The pump unit 1600 with its features described herein may be used with the jet massage unit 100 of FIG. 1 or the jet massage unit 1500 of FIG. 15. In one aspect, the pump unit 1600 may be used as part of another jet massage unit not described here. In one example, the reservoir 1620 holds one or more of bath oil, soap, bath salt, aromatic oil, or essential oil, in either liquid or powder form, which are mixed into the water stream to enhance the user's hydro-therapeutic massage.

One skilled in the art would understand that the steps disclosed herein may be interchanged in their order without departing from the scope and spirit of the present disclosure. Also, one skilled in the art would understand that the steps disclosed herein are not exclusive and other steps may be included or one or more of the steps disclosed herein may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, a processing units (a.k.a. processor) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art. In one aspect, the computer-readable medium includes non-transitory computer-readable medium.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A jet massage device comprising:
a pump unit submersible in liquid;
an electronic unit electrically coupled to the pump unit, wherein the electronic unit includes a programmable component for determining one or more of the following of the pump unit: power ramp, voltage level, current level, water flow volume, water flow rate or frequency pulsing of a water stream; and
a spa jet assembly, coupled to the pump unit and the electronic unit for delivering the water stream.

2. The jet massage device of claim 1, further comprising a remote control wireless technology coupled to the electronic unit for turning the jet massage device ON or OFF.

3. The jet massage device of claim 2, wherein the remote control further comprises features for adjusting through the electronic unit one or more of the following of the pump unit: power ramp, voltage level, current level, water flow volume, water flow rate or frequency pulsing of the water stream.

4. The jet massage device of claim 1, wherein the pump unit comprises a pump motor, a strainer and a pump housing for housing the pump motor and the strainer.

5. The jet massage device of claim 4, wherein the pump unit further comprises a reservoir for dispensing liquid or powder additives.

6. The jet massage device of claim 4, wherein the pump housing includes a clip-type holder for holding the spa jet assembly.

7. The jet massage device of claim 1, wherein the spa jet assembly is coupled to the pump unit through a water supply tube.

8. The jet massage device of claim 7, wherein the spa jet assembly is coupled to an air supply tube, wherein different massage sensations may be achieved by manually covering portions of an opening of the air supply tube.

9. The jet massage device of claim 7, wherein the spa jet assembly is coupled to an air supply tube, wherein different massage sensations may be achieved by a mechanical valve associated with the air supply tube.

10. The jet massage device of claim 1, wherein the spa jet assembly is a directional spa jet assembly.

11. The jet massage device of claim 1, wherein the spa jet assembly is a whirly rotating spa jet assembly.

12. The jet massage device of claim 1, further comprising a jet stand for holding the spa jet assembly, wherein the jet stand comprises a plurality of coil sections with each coil section having a varying coil winding from each of the other plurality of coil sections.

13. The jet massage device of claim 1, wherein the electronic unit is electrically spliced on an electrical cable coupled to the pump unit.

14. The jet massage device of claim 13, wherein the electronic unit comprises a DC control circuit.

15. The jet massage device of claim 14, wherein a first conductor and a second conductor are electrically spliced on the electrical cable, the first conductor being associated with a positive lead and the second conductor being associated with a negative lead.

16. The jet massage device of claim 15, wherein the first conductor, DC control circuit and the second conductor are electrically spliced on the electrical cable in a sequential line order such that the DC control circuit is between the first conductor and the second conductor.

17. The jet massage device of claim 16, further comprising a fuse, wherein the fuse is electrically spliced on the electrical cable.

18. The jet massage device of claim 1, wherein the water stream is aerated.
